(19) United States
(12) Patent Application Publication
(10) Pub. No.: US 2026/0141299 A1
(43) Pub. Date: May 21, 2026

(54) GENERATING VIRTUAL OBJECTS USING AUTOREGRESSIVE MODELS AND MULTI-SCALE TOKENIZATION

(71) Applicant: AUTODESK, INC., San Francisco, CA (US)

(72) Inventors: Arianna RAMPINI, Ciampino (IT); Medi TEJASWINI, Mannheim (DE); Chinthala Pradyumna REDDY, London (GB); Pradeep Kumar JAYARAMAN, Toronto (CA)

(21) Appl. No.: 19/313,589

(22) Filed: Aug. 28, 2025

Related U.S. Application Data
(60) Provisional application No. 63/721,349, filed on Nov. 15, 2024.

(51) Int. Cl. G06N 20/00

(52) U.S. Cl. CPC G06N 20/00

(57) ABSTRACT

The disclosed method for generating virtual objects includes generating, based on object data, compressed object data, performing, based on the object data and scales, operations to train a first untrained machine learning model to generate a first trained machine learning model comprising a trained codebook and a trained decoder, wherein the first trained machine learning model is trained to generate a reconstruction of the compressed object data, generating, based on the compressed object data and the scales and using the first trained machine learning model, token maps data, performing, based on the token maps data and conditions, operations to train a second untrained machine learning model to generate a second trained machine learning model comprising a trained autoregressive model, wherein the second trained machine learning model is trained to generate predicted token maps, and generating, based on the scales, conditions, and using both trained models, a virtual object.

### CROSS-REFERENCE TO RELATED APPLICATIONS

This application claims priority benefit of the U.S. Provisional Patent Application titled, “TECHNIQUES FOR IMPLEMENTING HIERARCHICAL WAVELET-GUIDED AUTOREGRESSIVE GENERATION FOR HIGH-FIDELITY 3D SHAPES,” filed on Nov. 15, 2024, and having Ser. No. 63/721,349. The subject matter of this related application is hereby incorporated herein by reference.

### BACKGROUND

### Technical Field

Embodiments of the present disclosure relate generally to computer graphics, artificial intelligence, and machine learning, and, more specifically, to techniques for generating virtual objects using autoregressive models and multi-scale tokenization.

### Description of the Related Art

Virtual object generation refers to the generation of digital representations of physical objects within simulated environments, augmented environments, virtual environments, or other environments. Virtual objects can include two-dimensional (2D) icons or assets, three-dimensional (3D) objects, animated characters, or other computer-generated structures. Virtual objects are commonly used in applications such as digital content creation, virtual and augmented reality (VR/AR), video games, simulations, digital twins, education, online commerce, and similar fields. For example, 3D objects—such as furniture, vehicles, anatomical parts, or household items—can be generated and placed into interactive scenes for visualization and interaction. In industrial design and prototyping, virtual objects enable rapid iteration without the need to perform intermediate physical manufacturing of models, prototypes, and similar elements. In entertainment and gaming, generated virtual characters and properties can populate immersive environments. In robotics and simulation, virtual objects can model obstacles, tools, or goals.

Conventional approaches for generating virtual objects include the use of autoregressive models. Autoregressive models generate virtual objects by sequentially predicting elements of the virtual object representation, where each element is conditioned on the previously generated elements. Autoregressive models are trained on large datasets of object structures and learn to capture spatial and semantic dependencies inherent in object geometries. Autoregressive models can be applied to various types of virtual content, including 3D meshes, point clouds, voxel grids, and symbolic shape encodings. For example, an autoregressive model can be trained to generate 3D models of chairs, vehicles, household items, or anatomical parts by generating object elements in a consistent sequence. Autoregressive models can operate unconditionally or in response to conditioning inputs, such as category labels, sketches, depth maps, or textual descriptions. In virtual and augmented reality environments, autoregressive models can be used to populate immersive scenes with context-appropriate objects. In robotics simulations, autoregressive models can generate tools, containers, or manipulable items for interaction. In digital content creation and e-commerce, autoregressive models can generate personalized product variants, animated props, or visual assets that adapt to user preferences.

One drawback of conventional approaches for generating virtual objects based on autoregressive models is the reliance on predicting highly granular elements, such as individual voxels, triangles, or point coordinates. Such reliance introduces significant computational overhead. Because autoregressive models generate outputs sequentially, the fine-grained prediction process becomes particularly time-consuming and resource-intensive for complex or high-resolution virtual objects, such as 3D shapes.

Another drawback of conventional approaches for generating virtual objects is that, by focusing on local token-level prediction, autoregressive models can struggle to maintain global geometric coherence. Such a limitation often results in artifacts or distortions that compromise the structural integrity of the generated virtual object.

As the foregoing illustrates, what is needed in the art are more effective techniques for generating virtual objects.

### SUMMARY

One embodiment sets forth a computer-implemented method for generating virtual objects. The method includes generating, based on object data, compressed object data. The method also includes performing, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data. The method further includes generating, based on the compressed object data, the one or more scales, and using the first trained machine learning model, token maps data. Furthermore, the method includes performing, based on the token maps data and one or more first conditions, one or more operations to train a second untrained machine learning model to generate a second trained machine learning model that comprises a trained autoregressive model, wherein the second trained machine learning model is trained to generate one or more predicted token maps. Furthermore, the method includes generating, based on the one or more scales, one or more second conditions, and using the first trained machine learning model and the second trained machine learning model, a virtual object.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques perform autoregressive generation over discrete multi-scale token maps instead of directly predicting highly granular geometric representations such as individual voxels, mesh vertices, or point coordinates. By operating on tokenized latent features at progressively coarser-to-finer spatial resolutions, the disclosed techniques reduce the sequence length required for autoregressive modeling, thereby improving generation efficiency and reducing computational overhead. Furthermore, by structuring the latent space as a hierarchy of quantized residual representations, the disclosed techniques capture global geometric structure early and refine local details at successive scales, which improves global consistency and mitigates common issues such as structural artifacts or distortions that result from token-level myopia in conventional autoregressive models.

These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A illustrates how the model trainer of FIG. 1 trains an autoencoder, according to various embodiments;

FIG. 3B is a more detailed illustration of the token maps data generator of FIG. 1, according to various embodiments

FIG. 3C illustrates how the model trainer of FIG. 1 trains an autoregressive model, according to various embodiments;

FIG. 4 is a more detailed illustration of the virtual object generation application of FIG. 1, according to various embodiments;

FIG. 5 is a flow diagram of method steps for training the autoencoder and the autoregressive model, according to various embodiments;

FIG. 6 is a flow diagram of method steps for training the autoencoder, according to various embodiments;

FIG. 7 is a flow diagram of method steps for generating the token maps data, according to various embodiments;

FIG. 8 is a flow diagram of method steps for training the autoregressive model, according to various embodiments; and

FIG. 9 is a flow diagram of method steps for generating virtual objects, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for generating virtual objects using autoregressive models and multi-scale tokenization. In various embodiments, a model trainer trains an autoencoder with object data. The autoencoder includes, without limitation, an encoder, a multi-scale tokenizer, a reconstruction decoder, and a residual calculator. During the training of the autoencoder, an object data compression module processes the object data and generates compressed object data. The encoder processes the compressed object data and generates one or more feature maps. The residual calculator uses a codebook included in the multi-scale tokenizer to process the feature maps and calculates one or more residual embeddings and one or more tokenized feature maps. The reconstruction decoder processes the tokenized feature maps and generates reconstructed compressed object data. A loss calculator calculates a first loss based on the reconstructed compressed object data, the compressed object data, the tokenized feature maps, and the residual embeddings. The model trainer uses the first loss to iteratively update the parameters of the autoencoder until one or more stopping criteria are met. Once the model trainer trains the autoencoder, a token maps data generator uses the trained autoencoder to process the compressed object data and generate token maps data. The model trainer then trains an autoregressive model based on the token maps data. During the training of the autoregressive model, the autoregressive model processes one or more conditions and token maps data and generates predicted token maps. The loss calculator processes one or more ground-truth token maps included in token maps data and predicted token maps and calculates a second loss. The model trainer uses the second loss to iteratively update the parameters of the autoregressive model until one or more stopping criteria are met. Once both the autoregressive model and the autoencoder are trained, a virtual object generation application can use the trained autoregressive model and the trained autoencoder to process one or more conditions and scales and generate one or more virtual objects.

The virtual object generation techniques of the present disclosure have many real-world applications. For example, the virtual object generation techniques can be used to generate virtual objects in virtual or augmented reality environments, video games, simulation platforms, or digital content creation pipelines. As another example, the virtual object generation techniques can be used in domains, such as architecture, education, or entertainment.

The above examples are not in any way intended to be limiting. As persons skilled in the art will appreciate, as a general matter, the virtual object generation techniques described herein can be implemented in any suitable application.

### System Overview

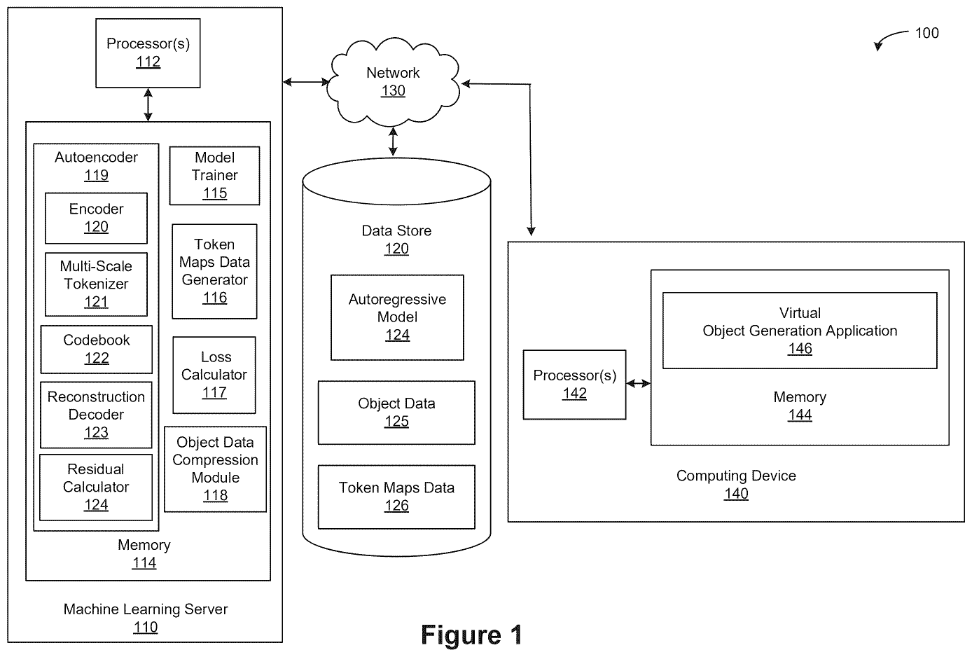

FIG. 1 illustrates a block diagram of a computer-based system 100 configured to implement one or more aspects of at least one embodiment. As shown, system 100 includes a machine learning server 110, a data store 120, and a computing device 140 in communication over a network 130. Network 130 can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a token maps data generator 116, a loss calculator 117, an object data compression module 118, and an autoencoder 119. Autoencoder 119 includes, without limitation, an encoder 120, a multi-scale tokenizer 121, a reconstruction decoder 123, and a residual calculator 124. Multi-scale tokenizer 121 includes, without limitation, a codebook 122. Data store 120 includes, without limitation, an autoregressive model 124, object data 125, and token maps data 126. Computing device 140 includes, without limitation, processor(s) 142 and a memory 144. Memory 144 includes, without limitation, a virtual object generation application 146.

Processor(s) 112 receive user input from input devices, such as a keyboard or a mouse. Processor(s) 112 could include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or similar technologies.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPUs can be included in and/or replaced with any type of virtual computing system, distributed computing system, and/or cloud computing environment, such as a public, private, or hybrid cloud system.

As shown, object data compression module 118 executes on one or more processors 112 of machine learning server 110 and is stored in system memory 114 of machine learning server 110. In various embodiments, object data compression module 118 processes object data 125 stored in datastore 120 and generates compressed object data. Object data 125, which can be stored in data store 120 or elsewhere (e.g., in memory 114), includes digital representations of physical or synthetic objects. In some examples, object data 125 can include 3D geometry, such as meshes, surface models, volumetric scans, point clouds, and/or similar structures. Object data 125 can be sourced from real-world sensors, 3D design tools, public datasets, and/or similar sources. The compressed object data includes compact representations derived from object data 125, such as wavelet-tree representations or other multi-resolution encodings that preserve geometric detail while reducing memory and computational requirements. For example, the compressed object data can include hierarchical wavelet coefficient grids, downsampled multi-scale voxel representations, or sparse tensor encodings that capture localized features.

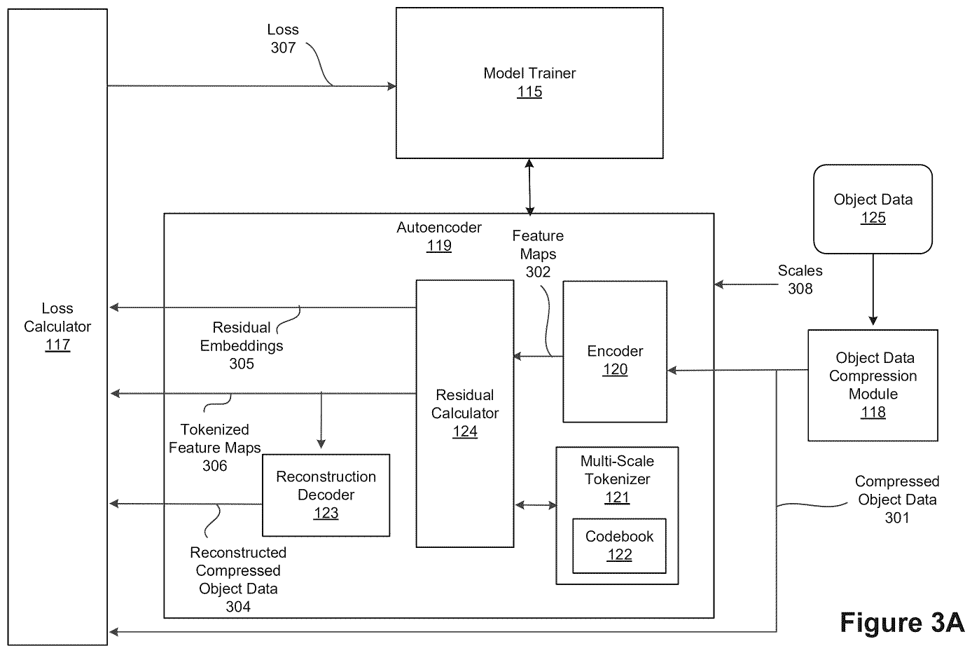

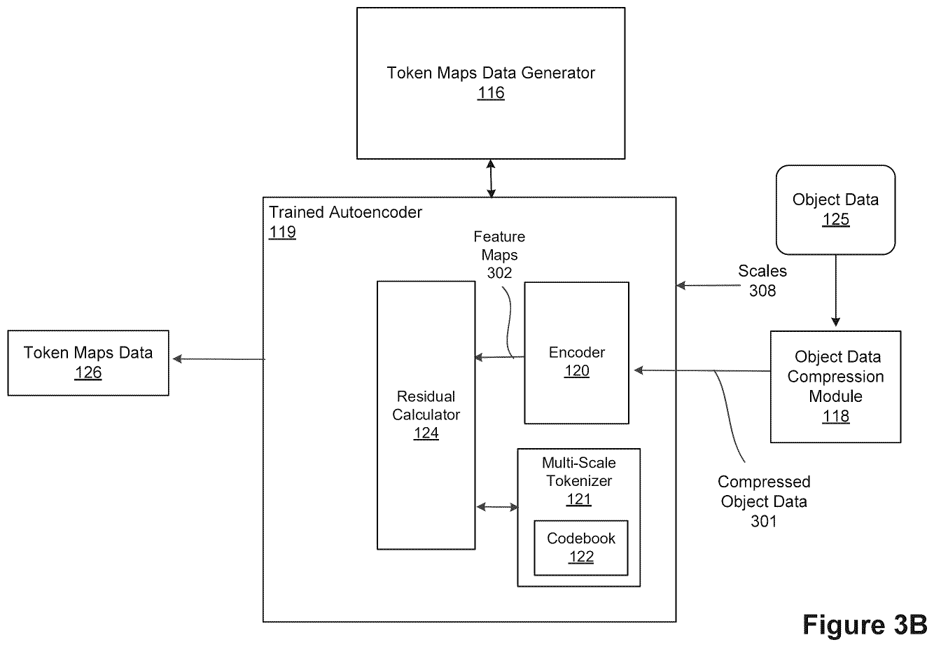

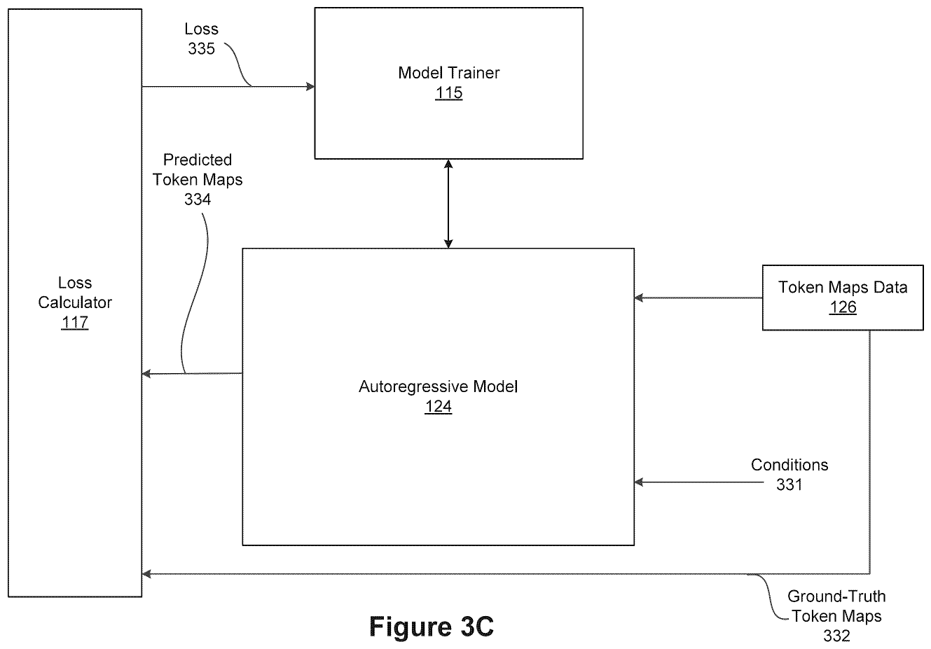

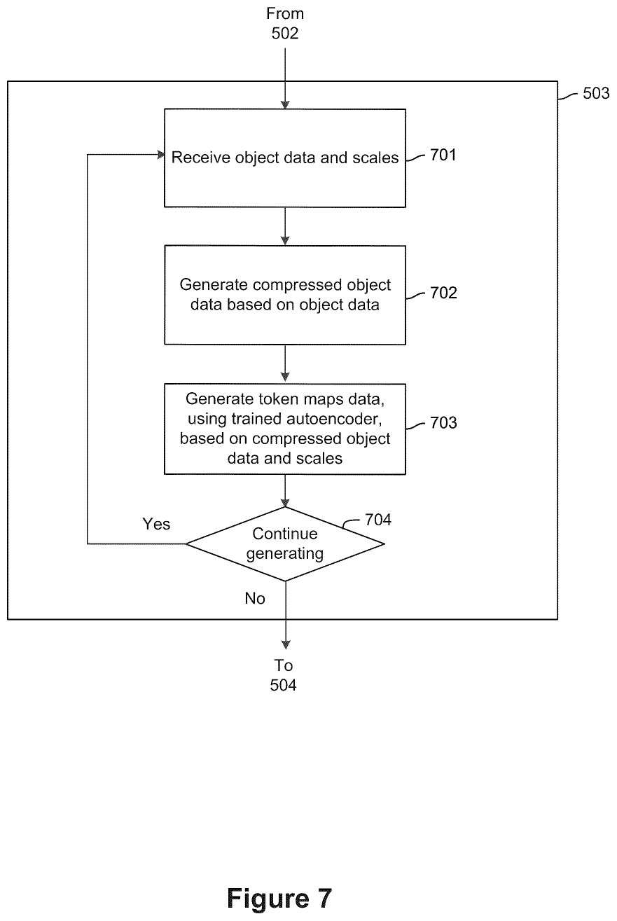

As shown, token maps data generator 116 executes on one or more processors 112 of machine learning server 110 and is stored in system memory 114 of machine learning server 110. In various embodiments, token maps data generator 116 is an application that uses the trained autoencoder 119 to process object data 125 and one or more scales received via one or more I/O devices (not shown) and generates token maps data 126. In some embodiments, the scales include various spatial resolutions of the compressed object data along the height (H), width (W), and depth (D) dimensions. Token maps data 126, which can be stored in data store 120 or elsewhere (e.g., in memory 114), includes one or more token maps. The token maps include multi-scale discrete token sequences. The token maps could include one or more levels of quantized feature embeddings derived from different spatial scales included in the scales of the compressed object data. For example, for a 3D object, such as a chair, the token maps can include a coarse-scale token map representing the overall shape (e.g., a basic silhouette of the frame of the chair) and finer-scale token maps that capture localized details, such as leg contours or armrest curvature. Token maps data generator 116 is described in greater detail in conjunction with FIGS. 3B and 7.

As shown, loss calculator 117 executes on one or more processors 112 of machine learning server 110 and is stored in system memory 114 of machine learning server 110. In various embodiments, loss calculator 117 is an application that calculates a first loss based on reconstructed object data and compressed object data and calculates a second loss based on one or more estimated residual embeddings and one or more residual embeddings.

As shown, model trainer 115 is an application that executes on one or more processors 112 of machine learning server 110 and is stored in a system memory 114 of machine learning server 110. Although shown as distinct from token maps data generator 116, loss calculator 117, and object data compression module 118 for illustrative purposes, in some embodiments, functionality of token maps data generator 116, loss calculator 117, object data compression module 118, and model trainer 115 can be combined into a single application or separated into any number of applications.

In some embodiments, model trainer 115 is configured to train one or more machine learning models, including autoencoder 119 and autoregressive model 124. Autoencoder 119 is a machine learning model, which is trained to process compressed object data and one or more scales received via one or more I/O devices (not shown) and generate reconstructed object data based on object data 125. Autoencoder 119 includes, without limitation, encoder 120, multi-scale tokenizer 121, reconstruction decoder 123, and residual calculator 124. Autoregressive model 124 is another machine learning model, such as a neural network, which is trained to process one or more conditions received from one or more I/O devices and generate one or more predicted token maps based on token maps data 126. Techniques for training autoencoder 119 based on object data 125 and training autoregressive model 124 based on token maps data 126 are discussed in greater detail herein in conjunction with at least FIGS. 3A, 3C, 5, and 8. Autoregressive model 124 can be stored in data store 120. In some embodiments, data store 120 can include any storage device or devices, such as fixed disc drive(s), flash drive(s), optical storage, network-attached storage (NAS), and/or a storage area network (SAN). Although shown as accessible over network 130, in at least one embodiment machine learning server 110 can include data store 120.

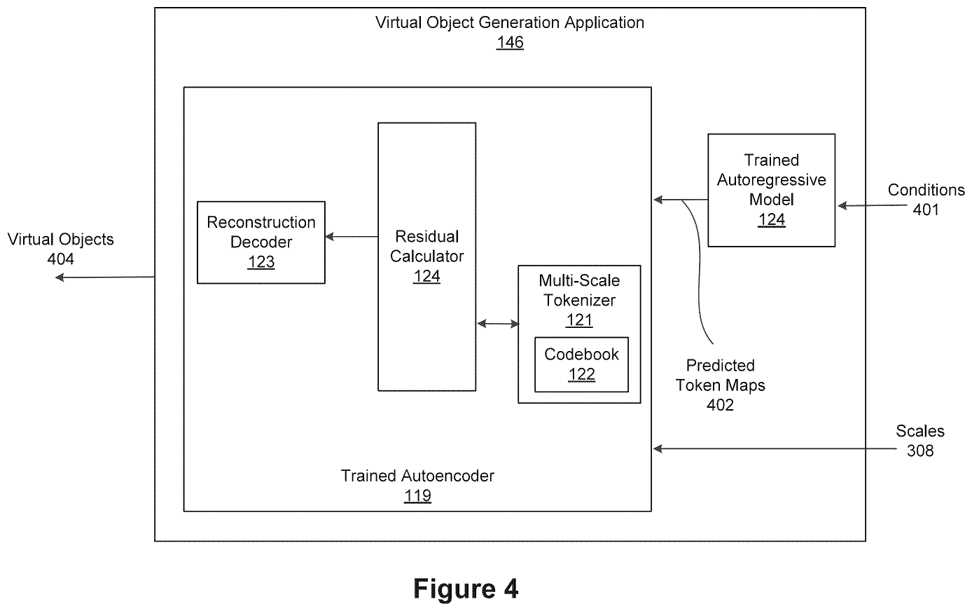

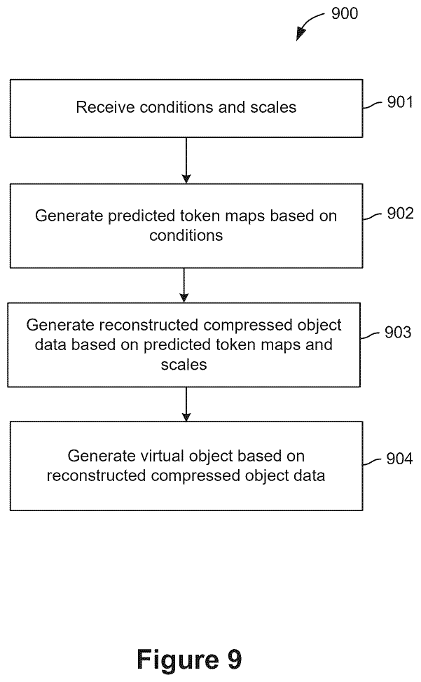

As shown, virtual object generation application 146 uses autoregressive model 124, which is stored in data store 120 and accessed over network 130, and reconstruction decoder 123 and a codebook included in multi-scale tokenizer 121 and executes on processor(s) 142 of computing device 140. Once trained, autoregressive model 124 along with trained autoencoder 119 can be deployed, such as via virtual object generation application 146, to generate one or more virtual objects. Virtual object generation application 146 is discussed in greater detail herein in conjunction with at least FIGS. 4 and 9. Memory 144 and processor(s) 142 can be similar to memory 114 and processor(s) 112 of machine learning server 110, described above.

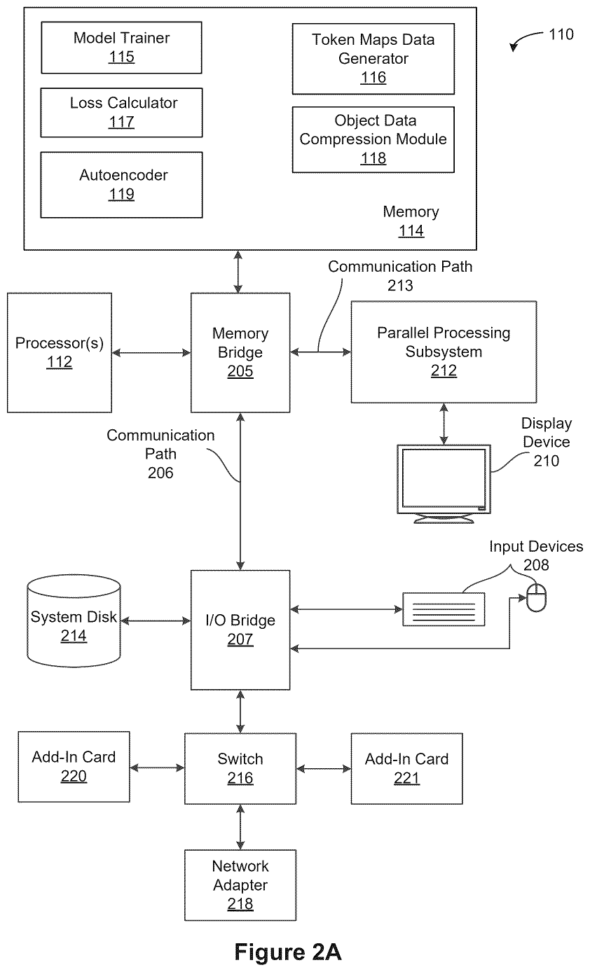

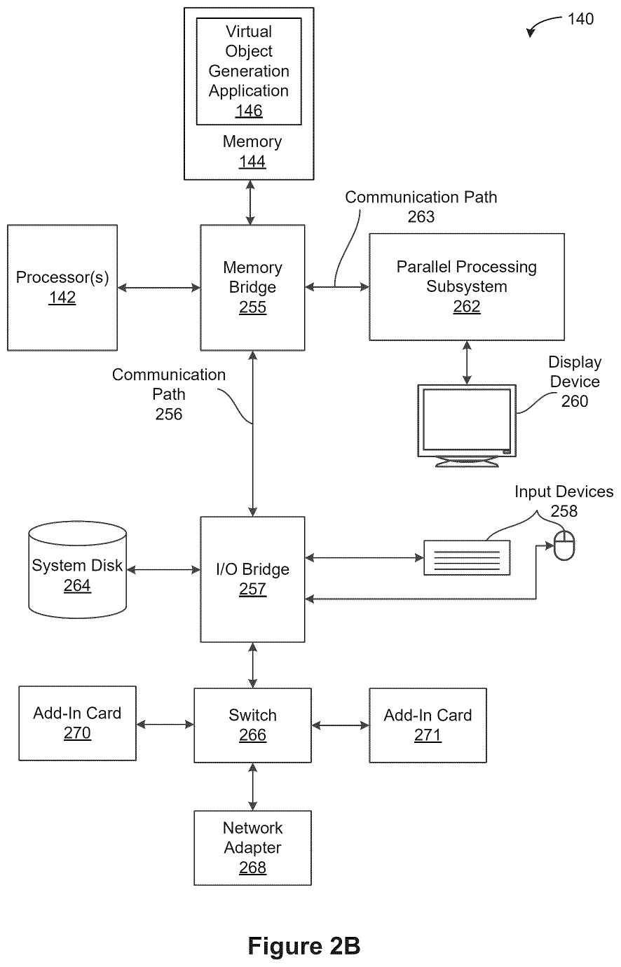

FIG. 2A provides a more detailed illustration of machine learning server 110 of FIG. 1, according to various embodiments. Machine learning server 110 could include any type of computing system, including, without limitation, a server machine, a server platform, a desktop machine, a laptop machine, a handheld/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or similar devices, and forward the input information to processor(s) 112 for processing. In some embodiments, machine learning server 110 could be a server machine in a cloud computing environment. In such embodiments, machine learning server 110 could not include input devices 208 but could receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that could be configured to store content and applications and data for use by processor(s) 142 and parallel processing subsystem 212. In one embodiment, system disk 214 provides non-volatile storage for applications and data and could include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and similar components could be connected to I/O bridge 207 as well.

In various embodiments, memory bridge 205 could be a Northbridge chip, and I/O bridge 207 could be a Southbridge chip. In addition, communication paths 206 and 213, as well as other communication paths within machine learning server 110, could be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that could be any conventional cathode ray tube, liquid crystal display, light-emitting diode display, and/or similar technologies. In such embodiments, parallel processing subsystem 212 could incorporate circuitry optimized for graphics and video processing, including, for example, video output circuitry. Such circuitry could be incorporated across one or more parallel processing units (PPUs), also referred to herein as parallel processors, included within parallel processing subsystem 212.

In some embodiments, parallel processing subsystem 212 incorporates circuitry optimized for general purpose and/or compute processing. Again, such circuitry could be incorporated across one or more PPUs included within parallel processing subsystem 212, which are configured to perform such general-purpose and/or compute operations. In yet other embodiments, the one or more PPUs included within parallel processing subsystem 212 could be configured to perform graphics processing, general-purpose processing, and/or compute processing operations. System memory 114 includes at least one device driver configured to manage the processing operations of the one or more PPUs within parallel processing subsystem 212. In addition, system memory 114 includes, without limitation, a model trainer 115, a token maps data generator 116, a loss calculator 117, an object data compression module 118, and an autoencoder 119. Although described herein primarily with respect to a model trainer 115, a token maps data generator 116, a loss calculator 117, an object data compression module 118, and an autoencoder 119, techniques disclosed herein can also be implemented, either entirely or in part, in other software and/or hardware, such as in parallel processing subsystem 212.

In various embodiments, parallel processing subsystem 212 could be integrated with one or more of the other elements of FIG. 2A to form a single system. For example, parallel processing subsystem 212 could be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths could also be used. The PPU advantageously implements a highly parallel processing architecture, and the PPU could be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, could be modified as desired. For example, in some embodiments, system memory 114 could be connected to the processor(s) 112 directly rather than through memory bridge 205, and other devices could communicate with system memory 114 via memory bridge 205 and processor 112. In other embodiments, parallel processing subsystem 212 could be connected to I/O bridge 207 or directly to processor 112, rather than to memory bridge 205. In still other embodiments, I/O bridge 207 and memory bridge 205 could be integrated into a single chip instead of existing as one or more discrete devices. In some embodiments, one or more components shown in FIG. 2A could not be present. For example, switch 216 could be eliminated, and network adapter 218 and add-in cards 220, 221 would connect directly to I/O bridge 207. Lastly, in some embodiments, one or more components shown in FIG. 2A could be implemented as virtualized resources in a virtual computing environment, such as a cloud computing environment. In particular, the parallel processing subsystem 212 could be implemented as a virtualized parallel processing subsystem in at least one embodiment. For example, the parallel processing subsystem 212 could be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B provides a more detailed illustration of computing device 140 of FIG. 1, according to various embodiments. Computing device 140 could include any type of computing system, including, without limitation, a server machine, a server platform, a desktop machine, a laptop machine, a handheld/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or similar devices, and forward the input information to processor(s) 142 for processing. In some embodiments, computing device 140 could be a server machine in a cloud computing environment. In such embodiments, computing device 140 could not include input devices 258 but could receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that could be configured to store content and applications and data for use by processor(s) 142 and parallel processing subsystem 262. In one embodiment, system disk 264 provides non-volatile storage for applications and data and could include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and similar components could be connected to I/O bridge 257 as well.

In various embodiments, memory bridge 255 could be a Northbridge chip, and I/O bridge 257 could be a Southbridge chip. In addition, communication paths 256 and 263, as well as other communication paths within computing device 140, could be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that could be any conventional cathode ray tube, liquid crystal display, light-emitting diode display, and/or similar technologies. In such embodiments, parallel processing subsystem 262 could incorporate circuitry optimized for graphics and video processing, including, for example, video output circuitry. Such circuitry could be incorporated across one or more parallel processing units (PPUs), also referred to herein as parallel processors, included within parallel processing subsystem 262.

In some embodiments, parallel processing subsystem 262 incorporates circuitry optimized for general purpose and/or compute processing. Again, such circuitry could be incorporated across one or more PPUs included within parallel processing subsystem 262, which are configured to perform such general-purpose and/or compute operations. In yet other embodiments, the one or more PPUs included within parallel processing subsystem 262 could be configured to perform graphics processing, general-purpose processing, and/or compute processing operations. System memory 144 includes at least one device driver configured to manage the processing operations of the one or more PPUs within parallel processing subsystem 262. In addition, system memory 144 includes virtual object generation application 146. Although described herein primarily with respect to virtual object generation application 146, techniques disclosed herein can also be implemented, either entirely or in part, in other software and/or hardware, such as in parallel processing subsystem 262.

In various embodiments, parallel processing subsystem 262 could be integrated with one or more of the other elements of FIG. 2B to form a single system. For example, parallel processing subsystem 262 could be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths could also be used. The PPU advantageously implements a highly parallel processing architecture, and the PPU could be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, could be modified as desired. For example, in some embodiments, system memory 144 could be connected to processor(s) 142 directly rather than through memory bridge 255, and other devices could communicate with system memory 144 via memory bridge 255 and processor 142. In other embodiments, parallel processing subsystem 262 could be connected to I/O bridge 257 or directly to processor 142, rather than to memory bridge 255. In still other embodiments, I/O bridge 257 and memory bridge 255 could be integrated into a single chip instead of existing as one or more discrete devices. In some embodiments, one or more components shown in FIG. 2B could not be present. For example, switch 266 could be eliminated, and network adapter 268 and add-in cards 270, 271 would connect directly to I/O bridge 257. Lastly, in some embodiments, one or more components shown in FIG. 2B could be implemented as virtualized resources in a virtual computing environment, such as a cloud computing environment. In particular, parallel processing subsystem 262 could be implemented as a virtualized parallel processing subsystem in at least one embodiment. For example, parallel processing subsystem 262 could be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Autoencoder Using Object Data

FIG. 3A illustrates how model trainer 115 trains autoencoder 119, according to various embodiments. As shown, autoencoder 119 includes, without limitation, encoder 120, multi-scale tokenizer 121, reconstruction decoder 123, and residual calculator 124. Multi-scale tokenizer 121 includes, without limitation, codebook 122. In operation, model trainer 115 trains autoencoder 119 with object data 125. During the training of autoencoder 119, object data compression module 118 processes object data 125 and generates compressed object data 301. Encoder 120 processes compressed object data 301 and generates one or more feature maps 302. Residual calculator 124 interacts with multi-scale tokenizer 121 and processes feature maps 302 and calculates one or more residual embeddings 305 and tokenized feature maps 306. Reconstruction decoder 123 processes tokenized feature maps 306 and generates reconstructed compressed object data 304. Loss calculator 117 calculates loss 307 based on reconstructed compressed object data 304, compressed object data 301, residual embeddings 305, and tokenized feature maps 306. Model trainer 115 uses loss 307 to iteratively update the parameters of autoencoder 119 until one or more stopping criteria are met.

Object data compression module 118 processes object data 125 and generates compressed object data 301. In some embodiments, object data compression module 118 applies one or more spatial compression techniques, such as wavelet transforms, resolution down sampling, volumetric projection, and/or the like, to reduce the dimensionality and redundancy of object data 125.

Autoencoder 119 processes compressed object data 301 and scales 308 and generates residual embeddings 305, tokenized feature maps 306, and reconstructed compressed object data 304. Autoencoder 119 includes encoder 120, multi-scale tokenizer 121, reconstruction decoder 123, and residual calculator 124. Multi-scale tokenizer 121 includes, without limitation, codebook 122. In various embodiments, encoder 120 includes a neural network that extracts latent features from compressed object data 301. In some embodiments, encoder 120 includes a three-dimensional convolutional neural network (3D CNN) that applies a series of convolutional, normalization, and activation layers to capture local and global geometric structures from the input volume included in compressed object data 301. In some embodiments, encoder 120 includes a transformer-based architecture with self-attention mechanisms that model long-range dependencies within compressed object data 301. In some embodiments, encoder 120 includes a hybrid architecture combining 3D CNN blocks with attention layers or residual connections to enhance feature extraction at multiple spatial scales. The resulting feature maps 302 include a compressed, learnable embedding of compressed object data 301.

Residual calculator 124 interacts with multi-scale tokenizer 122 and processes feature maps 302 and scales 308 and generates residual embeddings 305 and tokenized feature maps 306. In some embodiments, scales 308 include a fixed number K of target multi-dimensional resolutions, such as (H₁×W₁×D₁), (H₂×W₂×D₂), . . . , (H_{K}×W_{K}×D_{K)}in 3D, which correspond to progressively coarser or finer spatial representations of each object included in object data 125, where (Hₖ×Wₖ×Dₖ) represent the height, width, and depth, respectively, of the resolution at scale k. In various embodiments, residual calculator 124 receives feature maps 302 z∈ [symbol] ^{H×W×D×C} with C being the number of feature channels, and calculates a sequence of residual volumes {r⁽¹⁾, r⁽²⁾, . . . , r^{(K)}}(e.g., residual embeddings 305) at different spatial resolutions defined by scales 308. In some embodiments, residual calculator 124 interpolates or down-samples feature map 302 z and subtracts the accumulated reconstruction from previous levels to generate residual embedding 305 r^{(K)}. In some examples, residual calculator 124 calculates residual embedding 305 as described below:

$${r}^{( k )} = z - {\sum }_{j = 1}^{k - 1} {\hat{z}}^{( j )} \qquad ( Equation 1 )$$

where \hat{z}∈ [symbol] ^{H×W×D×C} represents the up-sampled previous decoded approximation (e.g., tokenized feature maps 306) at resolution level j. In some embodiments, each residual embedding 305 r^{(k)}∈ [symbol] ^{H}^{ₖ}^{×W}^{ₖ}^{×D}^{ₖ}^{×C} is passed to multi-scale tokenizer 121, which tokenizes residual embedding 305 using nearest-neighbor lookup in shared codebook 122 [symbol] ={e₁, . . . , e_{N}}⊂ [symbol] ^{C}, where eᵢ is a learnable code vector in the same feature space as r^{(k)}. The tokenization yields a token map fₖ∈{1, . . . , N}^{H}^{ₖ}^{×W}^{ₖ}^{×D}^{ₖ} which indexes the closest entry in codebook 122 at each spatial location. In some embodiments, residual calculator 124 then reconstructs the latent approximation (e.g., tokenized feature maps 306) for that scale level by performing codebook lookup from codebook 122 followed by a convolutional decoding layer, for example, as described by

$${\hat{z}}^{( k )} = conv ( 𝒞 [ {f}_{k} ] ) \qquad ( Equation 2 )$$

Reconstruction decoder 123 processes tokenized feature maps 306 and generates reconstructed compressed object data 304. In some embodiments, reconstruction decoder 123 up-samples each decoded approximation \hat{z}^{(k)} included in tokenized feature maps 306 to the full resolution (H×W×D) and accumulates the decoded approximation. In some examples, residual calculator 124 calculates reconstructed feature map \hat{z}ᵣₑₛ∈ [symbol] ^{H×W×D×C} as the sum of all reconstructed components:

$${\hat{z}}_{r e s} = {\sum }_{k = 1}^{K} {\hat{z}}^{( k )} \qquad ( Equation 3 )$$

In some embodiments, residual calculator 124 includes internal buffering or skip connections to propagate information across quantization stages, and optionally exposes token maps {fₖ} for training supervision or debugging purposes. In various embodiments, reconstruction decoder 123 applies one or more decoding operations, such as transposed convolutions, 3D up-sampling layers, residual decoder blocks, and/or the like, to transform the reconstructed feature map \hat{z}ᵣₑₛ into reconstructed compressed object data 304 Ŵ∈ [symbol] ^{H×W′×D′}. In some embodiments, reconstructed compressed object data 304 is in a transformed domain, such as a wavelet volume or other compact spatial encoding of 3D shape data.

Loss calculator 117 calculates loss 307 based on residual embeddings 305, tokenized feature maps 306, compressed object data 301, reconstructed compressed object data 304. In some embodiments, loss calculator 117 calculates a total loss 307 comprising two terms: a reconstruction loss and a commitment loss. The reconstruction loss is calculated as the squared L2 distance between the original compressed object data 301 W and the reconstructed compressed object data 304 Ŵ, generated by reconstruction decoder 123. The commitment loss is calculated as the cumulative squared L2 distance between each residual embedding 305 r^{(k)} and tokenized feature maps 306 \hat{z}^{(k)} across all K scales. In some examples, the total training loss 307 L is computed as:

$$L = {λ}_{recon} {‖ W - \hat{W} ‖}_{2}^{2} + {λ}_{c o m m i t} {\sum }_{k = 1}^{K} {‖ {r}^{( k )} - {\hat{z}}^{( k )} ‖}_{2}^{2} \qquad ( Equation 4 )$$

where λ_{recon} and λ_{commit} are scalar hyperparameters that specify the relative weights of the reconstruction and commitment loss terms, respectively.

In some embodiments, model trainer 115 uses loss 307 to update the parameters of autoencoder 119. In some embodiments, model trainer 115 performs backpropagation to update the learnable parameters of autoencoder 119. In some embodiments, model trainer 115 uses various optimization algorithms, such as stochastic gradient descent (SGD) algorithm or a variant thereof (e.g., adaptive moment estimation optimizer), with gradients computed with respect to the total loss 307. In various embodiments, training proceeds iteratively over a dataset of object data 125 until a predefined stopping criterion is satisfied. The stopping criterion includes but is not limited to reaching a maximum number of training epochs, detecting convergence based on the change in loss 307 over successive epochs falling below a threshold, or achieving a target validation performance metric. Once training is complete, model trainer 115 stores the trained autoencoder 119 in memory 114 or elsewhere.

FIG. 3B is a more detailed illustration of token maps data generator 116, according to various embodiments. In operation, object data compression module 118 processes object data 125 and generates compressed object data 301. Token maps data generator 116 uses the trained autoencoder 119 to process one or more scales 308 received from one or more I/O devices and compressed object data 301 and generate token maps data 126. Encoder 120 process compressed object data 301 and generates feature maps 302. Residual calculator 124 interacts with multi-scale tokenizer 121 to process feature maps 302 and generates token maps data 126.

Object data compression module 118 processes object data 125 and generates compressed object data 301. In some embodiments, object data compression module 118 applies one or more spatial compression techniques, such as wavelet transforms, resolution down sampling, volumetric projection, and/or the like, to reduce the dimensionality and redundancy of object data 125.

Token maps data generator 116 uses the trained autoencoder 119 to process one or more scales 308 received from one or more I/O devices and compressed object data 301 and generate token maps data 126. In some embodiments, encoder 120 processes compressed object data 301 and generates a feature map 302 z∈ [symbol] ^{H×W×D×C}. Residual calculator 124 processes feature map 302 z and calculates a sequence of residual embeddings {r⁽¹⁾, r⁽²⁾, . . . , r^{(K)}}, where each r^{(k)}∈ [symbol] ^{H}^{ₖ}^{×W}^{ₖ}^{×D}^{ₖ}^{×C}, at spatial resolutions defined by scales 308. For each k∈{1, . . . , K}, multi-scale tokenizer 122 quantizes (e.g., tokenizes) the residual embedding 305 r^{(k)} using nearest-neighbor lookup in the shared codebook 122 [symbol] ={e₁, . . . , e_{N}}⊂ [symbol] ^{C}, generating a discrete token map fₖ∈{1, . . . , N}^{H}^{ₖ}^{×W}^{ₖ}^{×D}^{ₖ}. Token maps data generator 116 stores token maps {f₁, f₂, . . . , f_{K}} in token maps data 126. In some embodiments, token maps data generator 116 continues generating token sequences for each object in object data 125 and terminates once all or a pre-defined number of objects included in object data 125 have been processed through the trained autoencoder 119.

FIG. 3C illustrates how model trainer 115 trains autoregressive model 124, according to various embodiments. In operation, model trainer 115 trains autoregressive model 124 based on token maps data 126. During the training of autoregressive model 124, autoregressive model 124 processes one or more conditions 331 and token maps data 126 and generates predicted token maps 334. Loss calculator 117 processes one or more ground-truth token maps 332 included in token maps data 126 and predicted token maps 334 and calculates loss 335. Model trainer 115 uses loss 335 to iteratively update the parameters of autoregressive model 124 until one or more stopping criteria are met.

Autoregressive model 124 processes token maps data 126 and conditions 331 and generates predicted token maps 334. In some embodiments, token maps data 126 includes multi-scale token sequences {f₁, f₂, . . . , f_{K}}, where each token map fₖ∈{1, . . . , N}^{H}^{ₖ}^{×W}^{ₖ}^{×D}^{ₖ} corresponds to quantized indices of codebook vectors representing residual embeddings at resolution level k. For each step k=2, . . . , K, autoregressive model 124 receives a flattened context sequence contextₖ=flatten({f₁, f₂, . . . , fₖ₋₁}), representing previously generated coarser-scale token maps. Autoregressive model 124 uses the context to autoregressively predict a distribution over possible tokens at the finer level k, yielding predicted token map 334 \hat{f}ₖ. In some embodiments, autoregressive model 124 includes a transformer architecture with cross-attention layers that incorporate external conditioning information via conditions 331. In some embodiments, queries and keys in the cross-attention layers are normalized to unit vectors to improve numerical stability. In some embodiments, trained autoregressive model 124 includes a decoder-only transformer architecture based on the Generative Pre-trained Transformer (GPT)-2 design. Conditions 331 include semantic, structural, or contextual cues that guide generation of predicted token maps 334. For example, conditions 331 can include natural language descriptions (e.g., “a red sports car with a spoiler”), categorical class labels (e.g., “airplane”, “furniture”), rough sketches or segmentation masks, or scene-level embeddings (e.g., from an upstream layout generator or 2D/3D image encoder). In some examples, autoregressive model 124 estimates each predicted token map 334 fᵢ based on all previous predicted token maps 334 f_{<i} and conditioning inputs c included in conditions 331, by calculating the likelihood described as:

$$p ( f \vert c ) = {\sum }_{i = 1}^{K} p ( {f}_{i} \vert {f}_{< i} , c ) \qquad ( Equation 5 )$$

Loss calculator 117 calculates loss 335 based on predicted token maps 334 and ground-truth token maps 332 included in token maps data 126. In some embodiments, loss calculator 117 calculates a cross-entropy loss between the predicted token maps 334 \hat{f}ᵢ and the ground-truth token map 332s fᵢ at each training step. In some examples, loss 335 is defined as:

$${ℒ}_{C E} = - {\sum }_{i = 1}^{K} log p ( {f}_{i} \vert {f}_{< i} , c ) \qquad ( Equation 6 )$$

which encourages autoregressive model 124 to assign high likelihood to the correct token map 334 \hat{f}ᵢ at each training step. In some embodiments, loss calculator 117 masks invalid or out-of-bound regions and normalizes loss 335 contributions across spatial locations and scale levels.

In some embodiments, model trainer 115 uses loss 335 to update the parameters of autoregressive model 124. In some embodiments, model trainer 115 performs backpropagation to update the learnable parameters of autoregressive model 124. In some embodiments, model trainer 115 uses various optimization algorithms, such as SGD algorithm or a variant thereof (e.g., adaptive moment estimation optimizer), with gradients computed with respect to loss 335. In various embodiments, training proceeds iteratively over token maps data 126 until a predefined stopping criterion is satisfied. The stopping criterion includes but is not limited to reaching a maximum number of training epochs, detecting convergence based on the change in loss 335 over successive epochs falling below a threshold, or achieving a target validation performance metric. Once training is complete, model trainer 115 stores the trained autoregressive model 124 in datastore 120 or elsewhere.

FIG. 4 is a more detailed illustration of virtual object generation application 146, according to various embodiments. As shown, virtual object generation application 146 uses the trained autoregressive model 124 and trained autoencoder 119 to process conditions 401 and scales 308 and generate virtual objects 404. In operation, trained autoregressive model 124 processes conditions 401 and generates predicted token maps 402. Trained autoencoder 119 uses codebook 122 included in multi-scale tokenizer 121, residual calculator 124, and reconstruction decoder 123 to process predicted token maps 402 and generate reconstructed compressed object data. Virtual objection generation application 146 processes the reconstructed compressed object data and generates virtual objects 404.

Trained autoregressive model 124 processes conditions 401 and generates predicted token maps 402. In some embodiments, trained autoregressive model 124 includes a decoder-only transformer architecture that generates multi-scale predicted token maps 402 by modeling the joint distribution as described in Equation 5. During inference, trained autoregressive model 124 begins generating predicted token maps 402 with a start token map or start embedding, and uses a transformer to sequentially predicts each token map 402 conditioned on the previous predicted token maps 402 and the embedding s derived from conditions 401. At each prediction step, the transformer applies cross-attention to s to incorporate condition 401 information, such as a text prompt or class label. Once all tokens in the flattened sequence are predicted, the tokens are reshaped back into the original spatial format to form the full set of predicted token maps 402.

Trained autoencoder 119 uses codebook 122 included in multi-scale tokenizer 121, residual calculator 124, and reconstruction decoder 123 to process predicted token maps 402 and generate reconstructed compressed object data. In some embodiments, each predicted token map 402 fₖ∈{1, . . . , N}^{H}^{ₖ}^{×W}^{ₖ}^{×D}^{ₖ} at resolution level k is passed to residual calculator 124, which retrieves the corresponding codebook embeddings from codebook 122 and applies a decoding operation, such as a convolutional layer, to generate the reconstructed latent approximation (e.g., tokenized feature maps 306), for example, as described in Equation 2. Reconstruction decoder 123 then up-samples reconstructed latent approximations to the full resolution and summed to compute the full reconstructed latent volume, for example, as described in Equation 3. Reconstruction decoder 123 processes \hat{z}ᵣₑₛ to generate reconstructed compressed object data. In some embodiments, virtual object generation application 146 processes reconstructed compressed object data and generates virtual objects 404. In some embodiments, virtual object generation application 146 applies one or more post-processing steps, such as inverse wavelet transforms, surface extraction (e.g., marching cubes), mesh generation, texture mapping, and/or the like, to convert reconstructed compressed object data into virtual objects 404.

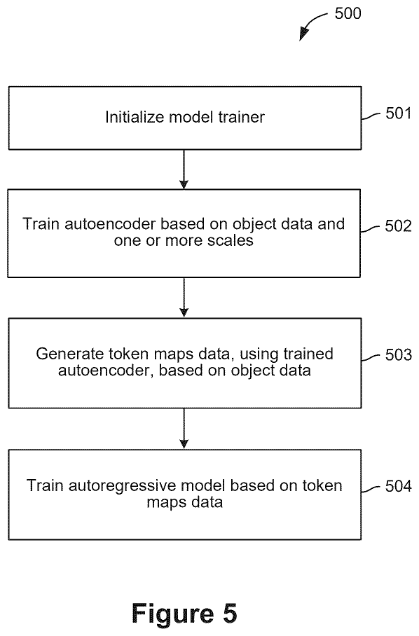

FIG. 5 is a flow diagram of method steps for training autoencoder 119 and autoregressive model 124, according to various embodiments. Although the method steps are described in conjunction with the systems of FIGS. 1-4, persons skilled in the art will understand that any system configured to perform the method steps in any order falls within the scope of the present disclosure.

As shown, a method 500 begins with step 501, where model trainer 115 is initialized. In some embodiments, model trainer 115 initializes model architecture parameters, such as the parameters of autoencoder 119 and autoregressive model 124. In some embodiments, model trainer 115 initializes training hyperparameters, such as learning rate, batch size, λ_{recon} and λ_{commit} as described in Equation 4, and number of epochs. In some embodiments, model trainer 115 initializes the optimization approach used in training, such as SGD, by setting parameters including learning rate, momentum, weight decay, a learning rate scheduler, and/or the like. Model trainer 115 also initializes the training and validation datasets used to train autoencoder 119 and could initialize any logging, checkpointing, or early stopping mechanisms.

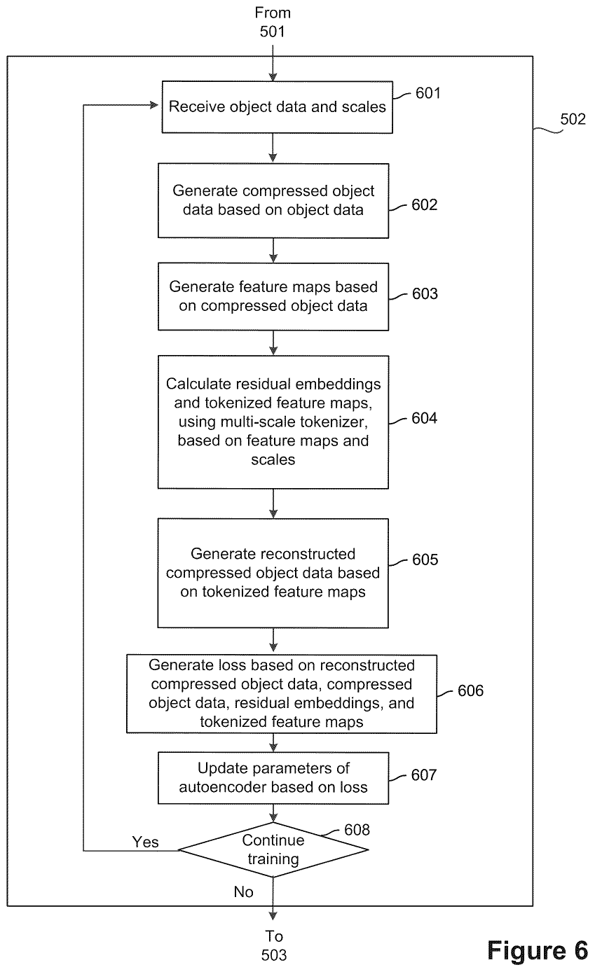

At step 502, model trainer 115 trains autoencoder 119 based on object data 125 and one or more scales 308. In some embodiments, model trainer 115 trains autoencoder 119 with object data 125. During the training of autoencoder 119, object data compression module 118 processes object data 125 and generates compressed object data 301. Encoder 120 processes compressed object data 301 and generates one or more feature maps 302. Residual calculator 124 interacts with multi-scale tokenizer 121 and processes feature maps 302 and calculates one or more residual embeddings 305 and tokenized feature maps 306. Reconstruction decoder 123 processes tokenized feature maps 306 and generates reconstructed compressed object data 304. Loss calculator 117 calculates loss 307 based on reconstructed compressed object data 304, compressed object data 301, residual embeddings 305, and tokenized feature maps 306. Model trainer 115 uses loss 307 to iteratively update the parameters of autoencoder 119 until one or more stopping criteria are met. Once training is complete, model trainer 115 stores the trained autoencoder 119 in memory 114 or elsewhere. Step 502 is described in greater detail in conjunction with FIG. 6.

At step 503, token maps data generator 116 generates token maps data 126, using trained autoencoder 119, based on object data 125. In some embodiments, object data compression module 118 processes object data 125 and generates compressed object data 301. Token maps data generator 116 uses the trained autoencoder 119 to process one or more scales 308 received from one or more I/O devices and compressed object data 301 and generate token maps data 126. Encoder 120 process compressed object data 301 and generates feature maps 302. Residual calculator 124 interacts with multi-scale tokenizer 121 to process feature maps 302 and generates token maps data 126. Step 503 is described in greater detail in conjunction with FIG. 7.

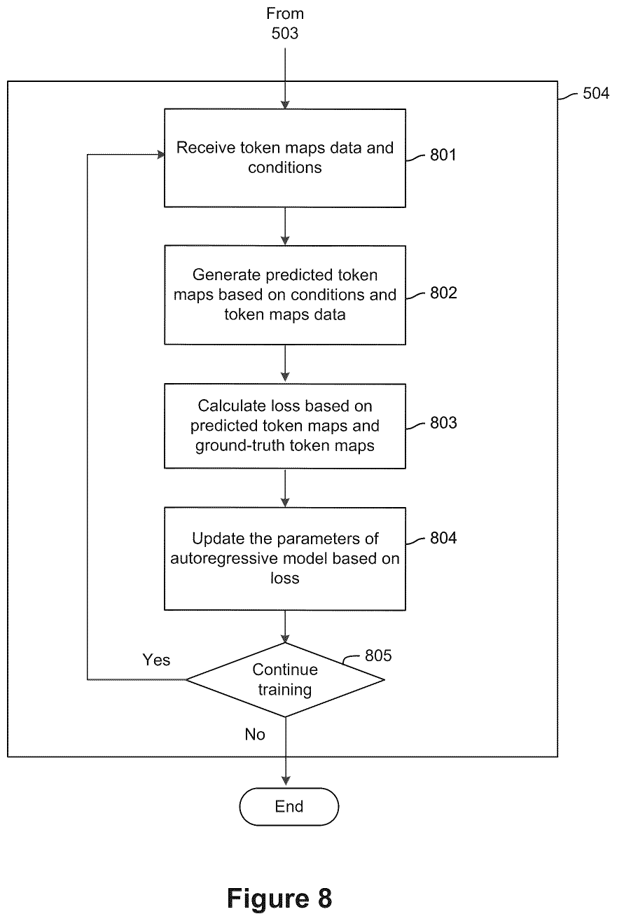

At step 504, model trainer 115 trains autoregressive model 124 based on token maps data 126. In some embodiments, During the training of autoregressive model 124, autoregressive model 124 processes one or more conditions 331 and token maps data 126 and generates predicted token maps 334. Loss calculator 117 processes one or more ground-truth token maps 332 included in token maps data 126 and predicted token maps 334 and calculates loss 335. Model trainer 115 uses loss 335 to iteratively update the parameters of autoregressive model 124 until one or more stopping criteria are met. Once training is complete, model trainer 115 stores the trained autoregressive model 124 in datastore 120 or elsewhere. Step 504 is described in greater detail in conjunction with FIG. 8.

FIG. 6 is a flow diagram of method steps for training autoencoder 119, according to various embodiments. Although the method steps are described in conjunction with the systems of FIGS. 1-4, persons skilled in the art will understand that any system configured to perform the method steps in any order falls within the scope of the present disclosure.

As shown, step 502 begins with step 601, where object data compression module 118 and autoencoder 119 receive object data 125 and scales 308, respectively. Object data 125, which can be stored in data store 120 or elsewhere (e.g., in memory 114), includes digital representations of physical or synthetic objects. In some examples, object data 125 can include 3D geometry, such as meshes, surface models, volumetric scans, point clouds, and/or similar structures. Object data 125 can be sourced from real-world sensors, 3D design tools, public datasets, and/or similar sources. Autoencoder 119 receives scales 308 via one or more I/O devices. In some embodiments, scales 308 include various spatial resolutions of compressed object data 301 along the height (H), width (W), and depth (D) dimensions.

At step 602, object data compression module 118 generates compressed object data 301 based on object data 125. In some embodiments, object data compression module 118 applies one or more spatial compression techniques, such as wavelet transforms, resolution down sampling, volumetric projection, and/or the like, to reduce the dimensionality and redundancy of object data 125.

At step 603, encoder 120 generates feature maps 302 based on compressed object data 301. In various embodiments, encoder 120 includes a neural network that extracts latent features from compressed object data 301. In some embodiments, encoder 120 includes a 3D CNN that applies a series of convolutional, normalization, and activation layers to capture local and global geometric structures from the input volume included in compressed object data 301. In some embodiments, encoder 120 includes a transformer-based architecture with self-attention mechanisms that model long-range dependencies within compressed object data 301. In some embodiments, encoder 120 includes a hybrid architecture combining 3D CNN blocks with attention layers or residual connections to enhance feature extraction at multiple spatial scales.

At step 604, residual calculator 124 calculates residual embeddings 305 and tokenized feature maps 306, using multi-scale tokenizer 121, based on feature maps 302 and scales 308. In some embodiments, scales 308 include a fixed number K of target multi-dimensional resolutions, such as (H₁×W₁×D₁), (H₂×W₂×D₂), . . . , (H_{K}×W_{K}×D_{K)}in 3D, which correspond to progressively coarser or finer spatial representations of each object included in object data 125, where (Hₖ×Wₖ×Dₖ) represent the height, width, and depth, respectively, of the resolution at scale k. In various embodiments, residual calculator 124 receives feature maps 302 z∈ [symbol] ^{H×W×D×C} and calculates a sequence of residual volumes {r⁽¹⁾, r⁽²⁾, . . . , r^{(K)}} (residual embeddings 305) at different spatial resolutions defined by scales 308. In some embodiments, residual calculator 124 interpolates or down-samples feature map 302 z and subtracts the accumulated reconstruction from previous levels to generate residual embedding 305 r^{(K)}. In some examples, residual calculator 124 calculates residual embedding 305 as described by Equation 1. In some embodiments, each residual embedding 305 r^{(k)}∈ [symbol] ^{H}^{ₖ}^{×W}^{ₖ}^{×D}^{ₖ}^{×C} is passed to multi-scale tokenizer 121, which tokenizes residual embedding 305 using nearest-neighbor lookup in shared codebook 122. The tokenization yields a token map fₖ∈{1, . . . , N}^{H}^{ₖ}^{×W}^{ₖ}^{×D}^{ₖ} which indexes the closest entry in codebook 122 at each spatial location. In some embodiments, residual calculator 124 then reconstructs the latent approximation (e.g., tokenized feature maps 306) for that scale level by performing codebook lookup from codebook 122 followed by a convolutional decoding layer, for example, as described by Equation 2.

At step 605, reconstruction decoder 123 generates reconstructed compressed data 304 based on tokenized feature maps 306. In some embodiments, reconstruction decoder 123 up-samples each decoded approximation \hat{z}^{(k)} included in tokenized feature maps 306 to the full resolution (H×W×D) generating an up-sampled decoded approximation and accumulates up-sampled decoded approximation. In some examples, residual calculator 124 calculates reconstructed feature map \hat{z}ᵣₑₛ∈ [symbol] ^{H×W×D×C} as the sum of all reconstructed components as described in Equation 3. In some embodiments, residual calculator 124 includes internal buffering or skip connections to propagate information across quantization stages, and optionally exposes token maps {fₖ} for training supervision or debugging purposes. In various embodiments, reconstruction decoder 123 applies one or more decoding operations, such as transposed convolutions, 3D up-sampling layers, residual decoder blocks, and/or the like, to transform the reconstructed feature map \hat{z}ᵣₑₛ into reconstructed compressed object data 304 Ŵ∈ [symbol] ^{H′×W′×D′}.

At step 606, loss calculator 117 generates loss 307 based on reconstructed compressed object data 304, compressed object data 301, residual embeddings 305, and tokenized feature maps 306. In some embodiments, loss calculator 117 calculates a total loss 307 comprising two terms: a reconstruction loss and a commitment loss. The reconstruction loss is calculated as the squared L2 distance between the original compressed object data 301 W and the reconstructed compressed object data 304 Ŵ, generated by reconstruction decoder 123. The commitment loss is calculated as the cumulative squared L2 distance between each residual embedding 305 r^{(k)} and tokenized feature maps 306 \hat{z}^{(k)} across all K scales. In some examples, the total training loss 307 L is computed as described in Equation 4.

At step 607, model trainer 115 updates parameters of autoencoder 119 based on loss 307. In some embodiments, model trainer 115 uses loss 307 to update the parameters of autoencoder 119. In some embodiments, model trainer 115 performs backpropagation to update the learnable parameters of autoencoder 119. In some embodiments, model trainer 115 uses various optimization algorithms, such as stochastic gradient descent SGD algorithm or a variant thereof (e.g., adaptive moment estimation optimizer), with gradients computed with respect to the total loss 307.

At step 608, model trainer 115 determines whether to continue training. In various embodiments, training proceeds iteratively over a dataset of object data 125 until a predefined stopping criterion is satisfied. The stopping criterion includes but is not limited to reaching a maximum number of training epochs, detecting convergence based on the change in loss 307 over successive epochs falling below a threshold, or achieving a target validation performance metric. Whenever model trainer 115 determines to continue training, step 502 returns to step 601. Whenever model trainer 115 determines not to continue training, the method 500 proceeds to step 503.

FIG. 7 is a flow diagram of method steps for generating token maps data 126, according to various embodiments. Although the method steps are described in conjunction with the systems of FIGS. 1-4, persons skilled in the art will understand that any system configured to perform the method steps in any order falls within the scope of the present disclosure.

As shown, step 503 begins with step 701, where object data compression module 118 and trained autoencoder 119 receive object data 125 and scales 308, respectively. Object data 125, which can be stored in data store 120 or elsewhere (e.g., in memory 114), includes digital representations of physical or synthetic objects. In some examples, object data 125 can include 3D geometry, such as meshes, surface models, volumetric scans, point clouds, and/or similar structures. Object data 125 can be sourced from real-world sensors, 3D design tools, public datasets, and/or similar sources. Autoencoder 119 receives scales 308 via one or more I/O devices. In some embodiments, scales 308 include various spatial resolutions of compressed object data 301 along the height (H), width (W), and depth (D) dimensions.

At step 702, object data compression module 118 generates compressed object data 310 based on object data 125. In some embodiments, object data compression module 118 applies one or more spatial compression techniques, such as wavelet transforms, resolution down sampling, volumetric projection, and/or the like, to reduce the dimensionality and redundancy of object data 125.

At step 703, token maps data generator 116 generates token maps data 126, using trained autoencoder 119, based on compressed object data 301 and scales 308. In some embodiments, encoder 120 processes compressed object data 301 and generates a feature map 302 z∈ [symbol] ^{H×W×D×C}. Residual calculator 124 processes feature map 302 z and calculates a sequence of residual embeddings {r⁽¹⁾, r⁽²⁾, . . . , r^{(K)}}, where each r^{(k)}∈ [symbol] ^{H}^{ₖ}^{×W}^{ₖ}^{×D}^{ₖ}^{×C} at spatial resolutions defined by scales 308. For each k∈{1, . . . , K}, multi-scale tokenizer 122 quantizes (e.g., tokenizes) the residual embedding 305 r^{(k)} using nearest-neighbor lookup in the shared codebook 122, generating a discrete token map fₖ∈{1, . . . , N}^{H}^{ₖ}^{×W}^{ₖ}^{×D}^{ₖ}. Token maps data generator 116 stores token maps {f₁, f₂, . . . , f_{K}} in token maps data 126.

At step 704, token maps data generator 116 determines whether to continue generating. In some embodiments, token maps data generator 116 continues generating token sequences for each object in object data 125 and terminates once all or a pre-defined number of objects included in object data 125 have been processed through the trained autoencoder 119. Whenever token maps data generator 116 determines to continue generating, step 503 returns to step 701. Whenever token maps data generator 116 determines not to continue generating, the method 500 proceeds to step 504.

FIG. 8 is a flow diagram of method steps for training autoregressive model 124, according to various embodiments. Although the method steps are described in conjunction with the systems of FIGS. 1-4, persons skilled in the art will understand that any system configured to perform the method steps in any order falls within the scope of the present disclosure.

As shown, step 504 begins step 801, where autoregressive model 124 receives token maps data 126 and conditions 331. Token maps data 126, which can be stored in data store 120 or elsewhere (e.g., in memory 114), includes one or more token maps. The token maps include multi-scale discrete token sequences. Conditions 331 include semantic, structural, or contextual cues that guide generation of predicted token maps 334.

At step 802, autoregressive model 124 generates predicted token maps 334 based on conditions 331 and token maps data 126. In some embodiments, token maps data 126 includes multi-scale token sequences {f₁, f₂, . . . , f_{K}}, where each token map fₖ∈{1, . . . , N}^{H}^{ₖ}^{×W}^{ₖ}^{×D}^{ₖ} corresponds to quantized indices of codebook vectors representing residual embeddings at resolution level k. For each step k=2, . . . , K, autoregressive model 124 receives a flattened context sequence contextₖ=flatten({f₁, f₂, . . . , fₖ₋₁}), representing previously generated coarser-scale token maps. Autoregressive model 124 uses the context to autoregressively predict a distribution over possible tokens at the finer level k, yielding predicted token map 334 fₖ. In some embodiments, autoregressive model 124 includes a transformer architecture with cross-attention layers that incorporate external conditioning information via conditions 331. In some embodiments, queries and keys in the cross-attention layers are normalized to unit vectors to improve numerical stability. In some embodiments, trained autoregressive model 124 includes a decoder-only transformer architecture based on the GPT-2 design. In some examples, autoregressive model 124 estimates each predicted token map 334 fᵢ based on all previous predicted token maps 334 f_{<i} and conditioning inputs c included in conditions 331, by calculating the likelihood as described in Equation 5.

At step 803, loss calculator 117 calculates loss 335 based on predicted token maps 334 and ground-truth token maps 332. In some embodiments, loss calculator 117 calculates a cross-entropy loss between the predicted token maps 334 \hat{f}ᵢ and the ground-truth token map 332s fᵢ at each training step. In some examples, loss 335 is defined as given in Equation 6. In some embodiments, loss calculator 117 masks invalid or out-of-bound regions and normalizes loss 335 contributions across spatial locations and scale levels.

At step 804, model trainer 115 updates the parameters of autoregressive model 124 based on loss 335. In some embodiments, model trainer 115 performs backpropagation to update the learnable parameters of autoregressive model 124. In some embodiments, model trainer 115 uses various optimization algorithms, such as SGD algorithm or a variant thereof (e.g., adaptive moment estimation optimizer), with gradients computed with respect to loss 335.

At step 805, model trainer 115 determines whether to continue training. In various embodiments, training proceeds iteratively over token maps data 126 until a predefined stopping criterion is satisfied. The stopping criterion includes but is not limited to reaching a maximum number of training epochs, detecting convergence based on the change in loss 335 over successive epochs falling below a threshold, or achieving a target validation performance metric. Whenever model trainer 115 determines to continue training, step 504 returns to step 801. Whenever model trainer 115 determines not to continue training, the method 500 terminates.

FIG. 9 is a flow diagram of method steps for generating virtual objects, according to various embodiments. Although the method steps are described in conjunction with the systems of FIGS. 1-4, persons skilled in the art will understand that any system configured to perform the method steps in any order falls within the scope of the present disclosure.

As shown, a method 900 begins with step 901, where virtual object generation application 146 receives conditions 401 and scales 308. In some embodiments, virtual object generation application receives conditions 401 and scales 308 via one or more I/O devices.

At step 902, trained autoregressive model 124 generates predicted token maps 402 based on conditions 401. In some embodiments, trained autoregressive model 124 includes a decoder-only transformer architecture that generates multi-scale predicted token maps 402 by modeling the joint distribution as described in Equation 5. During inference, trained autoregressive model 124 begins generating predicted token maps 402 with a start token map or start embedding, and uses a transformer to sequentially predicts each token map 402 conditioned on the previous predicted token maps 402 and the embedding s derived from conditions 401. At each prediction step, the transformer applies cross-attention to s to incorporate condition 401 information, such as a text prompt or class label. Once all tokens in the flattened sequence are predicted, the tokens are reshaped back into the original spatial format to form the full set of predicted token maps 402.

At step 903, trained autoencoder 119 generates reconstructed compressed object data based on predicted token maps 402 and scales 308. In some embodiments, trained autoencoder 119 uses codebook 122 included in multi-scale tokenizer 121, residual calculator 124, and reconstruction decoder 123 to process predicted token maps 402 and generate reconstructed compressed object data. In some embodiments, each predicted token map 402 fₖ∈{1, . . . , N}^{H}^{ₖ}^{×W}^{ₖ}^{×D}^{ₖ} at resolution level k is passed to residual calculator 124, which retrieves the corresponding codebook embeddings from codebook 122 and applies a decoding operation, such as a convolutional layer, to generate the reconstructed latent approximation (e.g., tokenized feature maps 306), for example, as described in Equation 2. Reconstruction decoder 123 then up-samples reconstructed latent approximations to the full resolution and summed to compute the full reconstructed latent volume, for example, as described in Equation 3. Reconstruction decoder 123 processes \hat{z}ᵣₑₛ to generate reconstructed compressed object data.

At step 904, virtual object generation application 146 generates virtual objects 404 based on reconstructed object data. In some embodiments, virtual object generation application 146 applies one or more post-processing steps, such as inverse wavelet transforms, surface extraction (e.g., marching cubes), mesh generation, texture mapping, and/or the like, to convert reconstructed compressed object data into virtual objects 404.

In sum, techniques are disclosed for generating virtual objects using autoregressive models and multi-scale tokenization. In various embodiments, a model trainer trains an autoencoder with object data. The autoencoder includes, without limitation, an encoder, a multi-scale tokenizer, a reconstruction decoder, and a residual calculator. During the training of the autoencoder, an object data compression module processes the object data and generates compressed object data. The encoder processes the compressed object data and generates one or more feature maps. The residual calculator uses a codebook included in the multi-scale tokenizer to process the feature maps and calculates one or more residual embeddings and one or more tokenized feature maps. The reconstruction decoder processes the tokenized feature maps and generates reconstructed compressed object data. A loss calculator calculates a first loss based on the reconstructed compressed object data, the compressed object data, the tokenized feature maps, and the residual embeddings. The model trainer uses the first loss to iteratively update the parameters of the autoencoder until one or more stopping criteria are met. Once the model trainer trains the autoencoder, a token maps data generator uses the trained autoencoder to process the compressed object data and generate token maps data. The model trainer then trains an autoregressive model based on the token maps data. During the training of the autoregressive model, the autoregressive model processes one or more conditions and token maps data and generates predicted token maps. The loss calculator processes one or more ground-truth token maps included in token maps data and predicted token maps and calculates a second loss. The model trainer uses the second loss to iteratively update the parameters of the autoregressive model until one or more stopping criteria are met. Once both the autoregressive model and the autoencoder are trained, a virtual object generation application can use the trained autoregressive model and the trained autoencoder to process one or more conditions and scales and generate one or more virtual objects.

At least one technical advantage of the disclosed techniques relative to the prior art is that the disclosed techniques perform autoregressive generation over discrete multi-scale token maps instead of directly predicting highly granular geometric representations such as individual voxels, mesh vertices, or point coordinates. By operating on tokenized latent features at progressively coarser-to-finer spatial resolutions, the disclosed techniques reduce the sequence length required for autoregressive modeling, thereby improving generation efficiency and reducing computational overhead. Furthermore, by structuring the latent space as a hierarchy of quantized residual representations, the disclosed techniques capture global geometric structure early and refines local details at successive scales, which improves global consistency and mitigates common issues such as structural artifacts or distortions that result from token-level myopia in conventional autoregressive models. These technical advantages provide one or more technological improvements over prior art approaches.
1. In some embodiments, a computer-implemented method for generating virtual objects comprises generating, based on object data, compressed object data, performing, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data, generating, based on the compressed object data, the one or more scales, and using the first trained machine learning model, token maps data, performing, based on the token maps data and one or more first conditions, one or more operations to train a second untrained machine learning model to generate a second trained machine learning model that comprises a trained autoregressive model, wherein the second trained machine learning model is trained to generate one or more predicted token maps, and generating, based on the one or more scales, one or more second conditions, and using the first trained machine learning model and the second trained machine learning model, a virtual object.
2. The computer-implemented method for claim 1, wherein the object data comprises at least one of one or more digital representations of physical objects or one or more digital representations of synthetic objects.
3. The computer-implemented method for claim 1, wherein generating the compressed object data comprises applying a wavelet transform to the object data.
4. The computer-implemented method for claim 1, wherein the one or more scales comprises a fixed number of one or more target multi-dimensional resolutions corresponding to progressively one or more finer spatial representations of each object included in the object data.
5. The computer-implemented method of any of clauses 1-4, wherein performing one or more operations to train the first untrained machine learning model comprises generating, based on the compressed object data, one or more feature maps using an untrained encoder, calculating, based on the one or more feature maps, the one or more scales, and using an untrained codebook, one or more residual embeddings and one or more tokenized feature maps, generating, based on the one or more tokenized feature maps, the reconstruction of the compressed object data using an untrained decoder, generating, based on the reconstruction of the compressed object data, the compressed object data, the one or more tokenized feature maps, and the one or more residual embeddings, a loss, and updating, based on the loss, one or more parameters of the first untrained machine learning model.
6. The computer-implemented method of any of clauses 1-5, wherein generating the loss comprises at least one of generating, based on the reconstruction of the compressed object data and the compressed object data, a reconstruction loss, or generating, based on the one or more tokenized feature maps and the one or more residual embeddings, a commitment loss.
7. The computer-implemented method of any of clauses 1-6, wherein generating the one or more tokenized feature maps comprises performing, based on the one or more residual embeddings, a nearest-neighbor lookup in the untrained codebook to generate one or more token maps, and generating, based on the one or more token maps, one or more tokenized feature maps using a convolutional decoding layer.
8. The computer-implemented method of any of clauses 1-7, wherein generating the reconstruction of the compressed object data comprises up-sampling a decoded approximation included in the one or more tokenized feature maps to a full resolution to generate an up-sampled decoded approximation, and accumulating the up-sampled decoded approximation to generate the reconstruction of the compressed object data.
9. The computer-implemented method of any of clauses 1-8, wherein performing one or more operations to train the second untrained machine learning model comprises generating, based on the token maps data and the one or more first conditions, the one or more predicted token maps, calculating, based on the one or more predicted token maps and one or more ground-truth token maps included in token maps data, a loss, and updating, based on the loss, one or more parameters of the second untrained machine learning model.
10. The computer-implemented method of any of clauses 1-9, wherein the loss comprises a cross-entropy loss between one or more predicted token maps and the one or more ground-truth token maps.
11. In some embodiments, one or more non-transitory computer-readable media store instructions that, when executed by one or more processors, cause the one or more processors to perform the steps of generating, based on object data, compressed object data, performing, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data, generating, based on the compressed object data, the one or more scales, and using the first trained machine learning model, token maps data, performing, based on the token maps data and one or more first conditions, one or more operations to train a second untrained machine learning model to generate a second trained machine learning model that comprises a trained autoregressive model, wherein the second trained machine learning model is trained to generate one or more predicted token maps, and generating, based on the one or more scales, one or more second conditions, and using the first trained machine learning model and the second trained machine learning model, a virtual object.
12. The one or more non-transitory computer-readable media of clause 11, wherein the one or more scales comprises a fixed number of one or more target multi-dimensional resolutions corresponding to progressively one or more finer spatial representations of each object included in the object data.
13. The one or more non-transitory computer-readable media of clauses 11 or 12, wherein performing one or more operations to train the first untrained machine learning model comprises generating, based on the compressed object data, one or more feature maps using an untrained encoder, calculating, based on the one or more feature maps, the one or more scales, and using an untrained codebook, one or more residual embeddings and one or more tokenized feature maps, generating, based on the one or more tokenized feature maps, the reconstruction of the compressed object data using an untrained decoder, generating, based on the reconstruction of the compressed object data, the compressed object data, the one or more tokenized feature maps, and the one or more residual embeddings, a loss, and updating, based on the loss, one or more parameters of the first untrained machine learning model.
14. The one or more non-transitory computer-readable media of any of clauses 11-13, wherein generating the loss comprises at least one of generating, based on the reconstruction of the compressed object data and the compressed object data, a reconstruction loss, or generating, based on the one or more tokenized feature maps and the one or more residual embeddings, a commitment loss.
15. The one or more non-transitory computer-readable media of any of clauses 11-14, wherein generating the one or more tokenized feature maps comprises performing, based on the one or more residual embeddings, a nearest-neighbor lookup in the untrained codebook to generate one or more token maps, and generating, based on the one or more token maps, one or more tokenized feature maps using a convolutional decoding layer.
16. The one or more non-transitory computer-readable media of any of clauses 11-15, wherein performing one or more operations to train the second untrained machine learning model comprises generating, based on the token maps data and the one or more first conditions, the one or more predicted token maps, calculating, based on the one or more predicted token maps and one or more ground-truth token maps included in token maps data, a loss, and updating, based on the loss, one or more parameters of the second untrained machine learning model.
17. The one or more non-transitory computer-readable media of any of clauses 11-16, wherein the second trained machine learning model comprises a transformer architecture with one or more cross-attention layers.
18. The one or more non-transitory computer-readable media of any of clauses 11-17, wherein the second trained machine learning model comprises a decoder-only transformer architecture in a Generative Pre-trained Transformer (GPT)-2 design.
19. The one or more non-transitory computer-readable media of any of clauses 11-18, wherein generating the virtual object comprises receiving the one or more second conditions and the one or more scales from one or more I/O devices, generating, based on the one or more second conditions, the one or more predicted token maps using the second trained machine learning model, generating, based on the one or more predicted token maps and the one or more scales, the reconstruction of compressed object data using the first trained machine learning model, and generating, based on the reconstruction of compressed object data, the virtual object.
20. In some embodiments, a system comprises one or more memories storing instructions, and one or more processors that are coupled to the one or more memories and, when executing the instructions, are configured to generate, based on object data, compressed object data, perform, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data, generate, based on the compressed object data, the one or more scales, and using the first trained machine learning model, token maps data, perform, based on the token maps data and one or more first conditions, one or more operations to train a second untrained machine learning model to generate a second trained machine learning model that comprises a trained autoregressive model, wherein the second trained machine learning model is trained to generate one or more predicted token maps, and generate, based on the one or more scales, one or more second conditions, and using the first trained machine learning model and the second trained machine learning model, a virtual object.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments could be embodied as a system, method or computer program product. Accordingly, aspects of the present disclosure could take the form of an entirely hardware embodiment, an entirely software embodiment (including firmware, resident software, micro-code, etc.) or an embodiment combining software and hardware aspects that could all generally be referred to herein as a “module” or “system.” Furthermore, aspects of the present disclosure could take the form of a computer program product embodied in one or more computer readable medium(s) having computer readable program code embodied thereon.

Any combination of one or more computer readable medium(s) could be utilized. The computer readable medium could be a computer readable signal medium or a computer readable storage medium. A computer readable storage medium could be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium could be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions could be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors could be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams could represent a module, segment, or portion of code, which comprises one or more executable instructions for implementing the specified logical function(s). It should also be noted that, in some alternative implementations, the functions noted in the block could occur out of the order noted in the figures. For example, two blocks shown in succession may, in fact, be executed substantially concurrently, or the blocks could sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure could be devised without departing from the basic scope thereof, and the scope thereof is determined by the claims that follow.

What is claimed is:

1. A computer-implemented method for generating virtual objects, the method comprising:
generating, based on object data, compressed object data;
performing, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data;
generating, based on the compressed object data, the one or more scales, and using the first trained machine learning model, token maps data;
performing, based on the token maps data and one or more first conditions, one or more operations to train a second untrained machine learning model to generate a second trained machine learning model that comprises a trained autoregressive model, wherein the second trained machine learning model is trained to generate one or more predicted token maps; and
generating, based on the one or more scales, one or more second conditions, and using the first trained machine learning model and the second trained machine learning model, a virtual object.

2. The computer-implemented method for claim 1, wherein the object data comprises at least one of one or more digital representations of physical objects or one or more digital representations of synthetic objects.

3. The computer-implemented method for claim 1, wherein generating the compressed object data comprises applying a wavelet transform to the object data.

4. The computer-implemented method for claim 1, wherein the one or more scales comprises a fixed number of one or more target multi-dimensional resolutions corresponding to progressively one or more finer spatial representations of each object included in the object data.

5. The computer-implemented method of claim 1, wherein performing one or more operations to train the first untrained machine learning model comprises:
generating, based on the compressed object data, one or more feature maps using an untrained encoder;
calculating, based on the one or more feature maps, the one or more scales, and using an untrained codebook, one or more residual embeddings and one or more tokenized feature maps;
generating, based on the one or more tokenized feature maps, the reconstruction of the compressed object data using an untrained decoder;
generating, based on the reconstruction of the compressed object data, the compressed object data, the one or more tokenized feature maps, and the one or more residual embeddings, a loss; and
updating, based on the loss, one or more parameters of the first untrained machine learning model.

6. The computer-implemented method of claim 5, wherein generating the loss comprises at least one of:
generating, based on the reconstruction of the compressed object data and the compressed object data, a reconstruction loss; or
generating, based on the one or more tokenized feature maps and the one or more residual embeddings, a commitment loss.

7. The computer-implemented method of claim 5, wherein generating the one or more tokenized feature maps comprises:
performing, based on the one or more residual embeddings, a nearest-neighbor lookup in the untrained codebook to generate one or more token maps; and
generating, based on the one or more token maps, one or more tokenized feature maps using a convolutional decoding layer.

8. The computer-implemented method of claim 5, wherein generating the reconstruction of the compressed object data comprises:
up-sampling a decoded approximation included in the one or more tokenized feature maps to a full resolution to generate an up-sampled decoded approximation; and
accumulating the up-sampled decoded approximation to generate the reconstruction of the compressed object data.

9. The computer-implemented method of claim 1, wherein performing one or more operations to train the second untrained machine learning model comprises:
generating, based on the token maps data and the one or more first conditions, the one or more predicted token maps;
calculating, based on the one or more predicted token maps and one or more ground-truth token maps included in token maps data, a loss; and
updating, based on the loss, one or more parameters of the second untrained machine learning model.

10. The computer-implemented method of claim 9, wherein the loss comprises a cross-entropy loss between one or more predicted token maps and the one or more ground-truth token maps.

11. One or more non-transitory computer-readable media storing instructions that, when executed by one or more processors, cause the one or more processors to perform the steps of:
generating, based on object data, compressed object data;
performing, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data;
generating, based on the compressed object data, the one or more scales, and using the first trained machine learning model, token maps data;
performing, based on the token maps data and one or more first conditions, one or more operations to train a second untrained machine learning model to generate a second trained machine learning model that comprises a trained autoregressive model, wherein the second trained machine learning model is trained to generate one or more predicted token maps; and
generating, based on the one or more scales, one or more second conditions, and using the first trained machine learning model and the second trained machine learning model, a virtual object.

12. The one or more non-transitory computer-readable media of claim 11, wherein the one or more scales comprises a fixed number of one or more target multi-dimensional resolutions corresponding to progressively one or more finer spatial representations of each object included in the object data.

13. The one or more non-transitory computer-readable media of claim 11, wherein performing one or more operations to train the first untrained machine learning model comprises:
generating, based on the compressed object data, one or more feature maps using an untrained encoder;
calculating, based on the one or more feature maps, the one or more scales, and using an untrained codebook, one or more residual embeddings and one or more tokenized feature maps;
generating, based on the one or more tokenized feature maps, the reconstruction of the compressed object data using an untrained decoder;
generating, based on the reconstruction of the compressed object data, the compressed object data, the one or more tokenized feature maps, and the one or more residual embeddings, a loss; and
updating, based on the loss, one or more parameters of the first untrained machine learning model.

14. The one or more non-transitory computer-readable media of claim 13, wherein generating the loss comprises at least one of:
generating, based on the reconstruction of the compressed object data and the compressed object data, a reconstruction loss; or
generating, based on the one or more tokenized feature maps and the one or more residual embeddings, a commitment loss.

15. The one or more non-transitory computer-readable media of claim 13, wherein generating the one or more tokenized feature maps comprises:
performing, based on the one or more residual embeddings, a nearest-neighbor lookup in the untrained codebook to generate one or more token maps; and
generating, based on the one or more token maps, one or more tokenized feature maps using a convolutional decoding layer.

16. The one or more non-transitory computer-readable media of claim 11, wherein performing one or more operations to train the second untrained machine learning model comprises:
generating, based on the token maps data and the one or more first conditions, the one or more predicted token maps;
calculating, based on the one or more predicted token maps and one or more ground-truth token maps included in token maps data, a loss; and
updating, based on the loss, one or more parameters of the second untrained machine learning model.

17. The one or more non-transitory computer-readable media of claim 11, wherein the second trained machine learning model comprises a transformer architecture with one or more cross-attention layers.

18. The one or more non-transitory computer-readable media of claim 11, wherein the second trained machine learning model comprises a decoder-only transformer architecture in a Generative Pre-trained Transformer (GPT)-2 design.

19. The one or more non-transitory computer-readable media of claim 11, wherein generating the virtual object comprises:
receiving the one or more second conditions and the one or more scales from one or more I/O devices;
generating, based on the one or more second conditions, the one or more predicted token maps using the second trained machine learning model;
generating, based on the one or more predicted token maps and the one or more scales, the reconstruction of compressed object data using the first trained machine learning model; and
generating, based on the reconstruction of compressed object data, the virtual object.

20. A system, comprising:
one or more memories storing instructions, and
one or more processors that are coupled to the one or more memories and, when executing the instructions, are configured to:
generate, based on object data, compressed object data,
perform, based on the compressed object data and one or more scales, one or more operations to train a first untrained machine learning model to generate a first trained machine learning model that comprises a trained codebook and a trained decoder, wherein the first trained machine learning model is trained to generate a reconstruction of the compressed object data,
generate, based on the compressed object data, the one or more scales, and using the first trained machine learning model, token maps data,
perform, based on the token maps data and one or more first conditions, one or more operations to train a second untrained machine learning model to generate a second trained machine learning model that comprises a trained autoregressive model, wherein the second trained machine learning model is trained to generate one or more predicted token maps, and
generate, based on the one or more scales, one or more second conditions, and using the first trained machine learning model and the second trained machine learning model, a virtual object.
